(19) United States
(12) Patent Application Publication
(10) Pub. No.: US 2025/0285503 A1
(43) Pub. Date: Sep. 11, 2025

(54) MANAGEMENT OF FUNDS IN A GAMING ENVIRONMENT

(71) Applicant: Sideplayr, Las Vegas, NV (US)

(72) Inventors: Jack Coronel, Las Vegas, NV (US); DeWayne Wooten, Henderson, NV (US)

(21) Appl. No.: 18/920,843

(22) Filed: Oct. 18, 2024

Related U.S. Application Data
(60) Provisional application No. 63/604,762, filed on Nov. 30, 2023.

(51) Int. Cl. G07F 17/32

(52) U.S. Cl. CPC G07F 17/3244; G07F 17/3241

(57) ABSTRACT

Technologies and implementations for facilitating securely adding funds in a gaming environment. The technologies and implementation may include a funds management module (FMM), where the FMM may be configured to facilitate securely adding of funds in a gaming environment. Establishment of a secured two device communication may be controlled and facilitated.

### CROSS REFERENCE TO RELATED APPLICATIONS

This application claims benefit of priority to U.S. Provisional Patent Application Ser. No. 63/604,762; filed Nov. 30, 2023; titled: MANAGEMENT OF FUNDS IN A GAMING ENVIRONMENT, which is incorporated in its entirety herein for all purposes.

### BACKGROUND

Unless otherwise indicated herein, the approaches described in this section are not prior art to the claims in this application and are not admitted to be prior art by inclusion in this section.

Integration of monetary systems within gaming machines has been a cornerstone of the gaming and entertainment industry for decades. However, several challenges persist in effectively incorporating and managing monetary transactions within these machines due to various technological, regulatory, and security complexities.

For example, gaming machines may operate within a highly regulated environment, subject to stringent laws and regulations governing monetary transactions, gambling, and consumer protection. Compliance with these legal frameworks may pose significant challenges in designing systems that ensure fairness, security, and adherence to established standards.

Handling of money within gaming machines may demand robust security measures to prevent fraud, theft, or unauthorized access. Ensuring the integrity of financial transactions and protecting user funds from potential breaches or exploitation may be considered paramount. Challenges may arise in implementing secure systems resilient to evolving cyber threats.

The evolving landscape of technology may introduce both opportunities and challenges. Integrating various payment methods, such as cash, credit/debit cards, mobile payments, or cryptocurrencies, may require sophisticated systems capable of accommodating diverse transactional modes while maintaining seamless functionality across different platforms and devices.

Gaming machine users may expect a smooth and intuitive experience when engaging with monetary transactions. Balancing the need for stringent security measures with user convenience may present a challenge, as complex authentication processes or transaction verifications may impede the user experience.

Ensuring the continuous and reliable operation of monetary systems within gaming machines may demand regular maintenance and monitoring. Challenges may arise in maintaining hardware, updating software, and managing backend systems to guarantee uninterrupted functionality without compromising security or compliance.

The gaming industry may be considered to be constantly evolving, with new technologies and consumer preferences driving innovation. Keeping pace with these changes while maintaining compatibility and compliance with existing frameworks may present an ongoing challenge for gaming machine developers and operators.

In light of these challenges, there exists a compelling need for inventive solutions that address the complexities of integrating monetary systems within gaming machines. Innovations that enhance security, streamline transactions, improve user experience, and ensure compliance with regulatory standards will significantly impact the gaming industry, fostering trust among users and stakeholders alike.

All subject matter discussed in this section of this document is not necessarily prior art and may not be presumed to be prior art simply because it is presented in this section. Plus, any reference to any prior art in this description is not and should not be taken as an acknowledgement or any form of suggestion that such prior art forms parts of the common general knowledge in any art in any country. Along these lines, any recognition of problems in the prior art are discussed in this section or associated with such subject matter should not be treated as prior art, unless expressly stated to be prior art. Rather, the discussion of any subject matter in this section should be treated as part of the approach taken towards the particular problem by the inventor(s). This approach in and of itself may also be inventive. Accordingly, the foregoing summary is illustrative only and not intended to be in any way limiting. In addition to the illustrative aspects, embodiments, and features described above, further aspects, embodiments, and features will become apparent by reference to the drawings and the following detailed description.

### SUMMARY

Described herein are various illustrative methods, systems, and apparatus for facilitating management of adding funds in a gaming environment.

Some example systems may include a processor, a storage medium, and a fund management module (FMM). In one example, the FMM may be configured to facilitate adding funds to a game, where the adding the funds may facilitated by a smart phone interacting with a two dimensional code such as, but not limited to, a Quick Response (QR) code.

The foregoing summary is illustrative only and not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates a system for an interaction of a fund management module (FMM), in accordance with various embodiments.

FIG. 2 illustrates a block diagram of system for facilitating for facilitating management of adding funds in a gaming environment, in accordance with various embodiments.

FIG. 3 illustrates an operational flow for facilitating securely adding funds to the gaming machine, in accordance with at least some of the embodiments described herein.

FIG. 4 illustrates an example computer program product, arranged in accordance with at least some embodiments described herein.

FIG. 5 is a block diagram illustrating an example computing device, such as might be embodied by a person skilled in the art, which is arranged in accordance with at least some embodiments of the present disclosure.

### DETAILED DESCRIPTION

The following description sets forth various examples along with specific details to provide a thorough understanding of the claimed subject matter. It will be understood by those skilled in the art after review and understanding of the present disclosure, however, that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, systems, and apparatus for facilitating management of adding funds in a gaming environment.

Prior to turning to the figures, some non-limiting example scenarios may be described to more fully understand the claimed subject matter. For example, some non-limiting example scenarios illustrating the utilization and implementation of the various embodiments of the present disclosure may be described.

In one non-limiting example scenario, a gaming environment such as, but not limited to, casino environment. In the casino environment, a gaming machine such as, but not limited to, a video poker machine may be provided. In this example scenario, a player may be playing video poker on the gaming machine, where the gaming machine may include a display configured to show images of the video cards including available funds. As the player plays the game, the player may run out of funds and would like to add funds to continue playing the game. The player may activate an interactive indicator on the gaming machine such as, but not limited to, a physical button or a graphical representation of a button on the display configured to indicate adding of funds.

In this example scenario, responsive to receiving the indication to add funds, the gaming machine may generate a machine-readable code such as, but not limited to, a Quick Response (QR) code. The player may utilize a personal communication device such as, but not limited to, a smartphone to scan the QR code. Responsive to scanning the QR code, the smartphone may launch an application (“app”). The app may generate an interface on the smartphone to facilitate adding of funds for the gaming machine.

In accordance with various embodiments, the app on the smartphone may be configured to securely communicate with the gaming machine as a closed loop system. Within the closed loop system, the app may include storage and/or utilization of a wide variety of value methods such as, but not limited to, credit card, debit card, reward points, gift card, credit of some kind to be used with the gaming machine, achievements, charms, bonuses, jackpots, etc., which may be accessed by the player. The value methods may be digitized and/or converted into some form of digital information to be used within the closed loop environment, where the digital information may be converted into funds for the gaming machine. The transfer of the digital information may show up substantially instantaneously and/or in real time in the gaming machine as funds. Additionally, the value methods may be configured to be shared and/or utilized across gaming platforms and/or users. For example, a bonus may be shared from multiple sources (e.g., from friends and/or family) facilitating group play of a game. Group play example may comprise of a single source of substantially similar funds to facilitate group play and/or syndicated play.

As a result, the experience of the player may be enhanced because there may not be the need for interaction with any other person or device to facilitate adding funds to the gaming machine.

In accordance with various embodiments, the approaches disclosed herein facilitate an isolated, closed, and/or self-contained methodology to add funds in a gaming environment, where the funds may be converted into and/or from a wide variety of digital information.

In some embodiments, the closed loop environment/network may include wired and/or wireless networks. In one example, the closed loop environment/network may include devices that may be included as internet of things (IoT) devices may be utilized alone and/or in conjunction with audio and/or video devices to facilitate adding funds to a gaming machine, and facilitate a variety of transactions and/or activities of a person with a device. Accordingly, For example, wireless communication methodologies may be utilized such as, but not limited to, Wi-Fi, IEEE 802 based, Bluetooth® type, Near Field Communication (NFC), radio-frequency identification (RFID), ad-hoc wireless network solutions (e.g., AirDrop), internet of things (IoT) related communication solutions, mesh local area network (LAN) type (e.g., ZigBee, Bluetooth Low Energy, Z-Wave, 6LoWPAN, Thread, etc.), and any combination thereof.

In some embodiments, the closed loop environment/network may include location based communication such as, but not limited to, geofencing. For example, in some embodiments, the personal device (e.g., smartphone) may be communicatively coupled with the internet, while the gaming device may not be communicatively coupled with the internet. As may be appreciated, because of the sensitivity of the gaming environments, in some of the above example scenarios, the personal device (e.g., smartphone) may be configured to not be able to scan the QR code unless the smartphone is in proximity to the gaming machine (i.e., geofencing). The geofencing may be facilitated by a variety of methodologies such as, but not limited to, NFC, GPS, visual location, etc.

In some embodiments, proximity and/or identity of a user may be determined by visual approaches. For example, a gaming device may be communicatively coupled with an image capture device (e.g., video surveillance device). The image capture device may facilitate image capture of the user, where the image may be utilized to determine identity of the user and/or proximity location of the user to the gaming device.

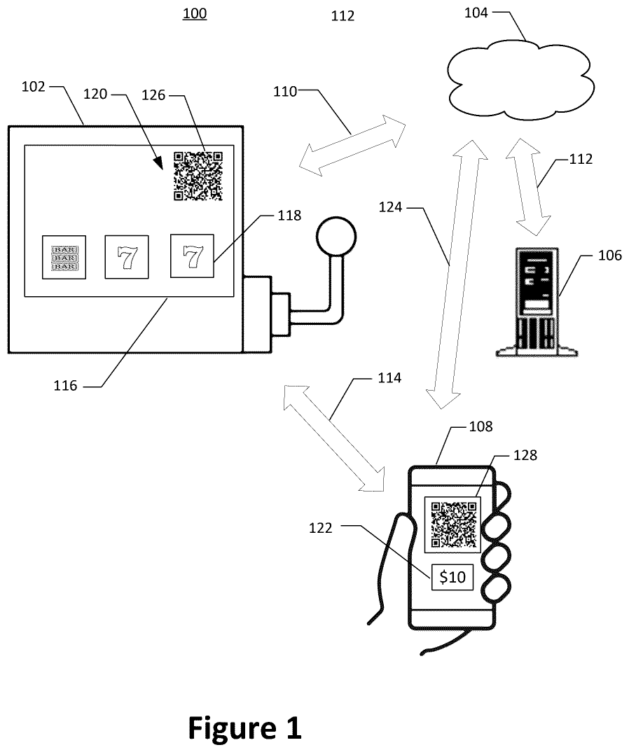

Turning now to FIG. 1, FIG. 1 illustrates a system for an interaction of a fund management module (FMM), in accordance with various embodiments. In FIG. 1, a system 100 may include a gaming machine 102, a network 104, a server 106, and a personal device 108. As shown in the system 100, the gaming machine 102 may be communicatively coupled with the network 104 via a communication link 110. The server 106 may be communicatively coupled with the network via a communication link 112. In the system 100, the game machine 102 may or may not be communicatively coupled with the personal device 108 (e.g., secure link 114), in accordance with one or more embodiments.

As shown in the system 100, the gaming machine 102 may include an interface 116, which may include a one or more game components 118. Additionally, the interface 116 may include a portion 120 for facilitating interaction with the personal device 108. In the system 100, the gaming machine 102 may receive an indication of adding funds (indication 122). The indication 122 may be initiated by the personal device 108 and communicated to the server 106 via a local area network (LAN) communication link (LAN 124). The LAN 124 may be a communication link that a guest of a gaming establishment may provide for its patrons/guests. The indication 122 may be communicated to the server 106, which may include some form of identification of the gaming machine 102 (e.g., gaming machine ID located on or proximate to the gaming machine 102). The server 106 may identify the gaming machine 102 and transmit the indication 122 to the gaming machine 102. Responsive to receiving the indication 122, the gaming machine 102, may cause to display a machine-readable code (code 126). As shown, the code 126 may be generated and displayed in the portion 120 of the interface 116. Displaying the code 126, where the code 126 may be configured to cause to launch an application on the personal device 108, may facilitate a secure communication between the gaming device 102 and the personal device 108, in accordance with one or more embodiments.

For example, once the code 126 is displayed on the interface 116, the personal device 108 may be utilized to read the code 126. Reading the code 126 utilizing the personal device 108 may cause an application to launch (e.g., funding app 128) on the personal device 108. The funding app 128 may cause to transmit a communication 114 to the gaming machine 102. The gaming machine 102 may receive the communication from the personal device 108 (i.e., from the funding app 128), where the gaming machine 102 may determine whether the received communication 114 includes data configured to establish a secure two device communication between the gaming machine 102 and the personal device 108. If the gaming machine 102 determines that the received communication 114 from the personal device 108 includes data configured to establish a secure two device communication, the gaming machine 102 may cause to establish the secure two device communication 114 between the gaming machine 102 and the personal device 108 based, at least in part, on the data. Once the secure two device communication 114 is established, the gaming machine 102 may cause the adding of the funds 122 to facilitate further game play by the user. In one example, the added funds may be displayed in the portion 120 of the interface 116. As a result, a secure method of adding funds in a gaming environment may be facilitated, in accordance with one or more embodiments.

In example, subsequent to the transfer of funds, the established two device communication 114 may time out and terminate the two device communication 114. For example, after the transfer of the funds, the two device communication 114 may be configured to terminate (e.g., disconnect) after a time period such as, but not limited to, seconds and/or minutes. In another example, the after the transfer of the funds, the two device communication 114 may be configured to terminate after a predetermined number of transfers. For example, the two device communication 114 may be configured to terminate after one, two, or a predetermined number of transfers. In yet another example, the after the transfer of the funds, the two device communication 114 may be configured to terminate after a predetermined amount of funds being transferred. For example, the two device communication 114 may be configured to terminate after a transfer of the amount of funds to be transferred, which may have initiated the transaction by the personal device.

It should be appreciated that the term funds may include a wide variety of capital, which may be in a variety of electronic forms. Some examples of capital may include, but not limited to, loyalty points, cryptocurrency, digital gift cards, credit/debit card based, electronic payment applications (e.g., Venmo, PayPal, etc.), in game prizes and/or bonus, non-fungible tokens (NFT), etc. Accordingly, the claimed subject matter is not limited in this respect.

It is contemplated that a variety of security methodologies may be employed in any of the interactions described herein. For example, during the establishment of the secure two device communication 114, the gaming machine 102 to cause the launched app on the personal device 108 to authenticate that the transaction. One example of authenticating the transaction may include, but not limited to, causing the app on the personal device 108 to request biometric authentication. Authenticating the transaction may help to facilitate further security of the methods disclosed herein. In another example, the server 106 (i.e., the provider of the gaming environment) may be configured to detect out of the ordinary type of activity. For example, the server 106 may be configured to learn the behavior of the game player (e.g., loyalty card), and the server 106 determines that the player is adding funds in an unusual manner (e.g., usually adds $10 increments but changed to $100 increments), the server 106 may be configured to transmit instructions to the gaming machine 102 to not generate the machine readable code. Instead, the gaming machine 102 may cause to display a message indicating further inquiry is needed. Further, the secure two device communication 114 may facilitate a wide variety of secure communication between the gaming machine 102 and the personal device 108. For example, the secure two device communication 114 may facilitate a two way stream for data such as, but not limited to, video data between the two devices. The app on the personal device 108 may be configured to facilitate streaming of the game play between the gaming device 102 and the personal device 108. Accordingly, the methods and systems disclosed herein includes a wide variety of security approaches.

In FIG. 1, the interface 116 may be a wide variety of interfaces such as, but not limited to, a user interface, a two dimensional interface, a three dimensional interface (e.g., virtual reality interface and/or augmented reality), a touchscreen, and/or so forth.

In FIG. 1, if it is determined that the received communication 114 from the personal device 108 does not include the data, the gaming machine 102 may prevent establishing communication between the gaming machine 102 and the personal device 108. In some examples, the data may include personal data such as, but not limited to, personal identification number, account number, lack of portal (i.e., application not available or not installed), a locked account, a banned player information, etc.

In one example, the indication 122 may be activated by an application such as, but not limited to, the funding app 128. In another example, the indication 122 may be activated by a button on the gaming machine 102.

The communication 114 between the gaming machine 102 and the personal device 108 may utilize one or more short communication protocols. For example, the communication between 114 may include short communication protocols such as, but not limited to, universal asynchronous receiver-transmitter (UART), serial peripheral interface (SPI), inter-integrated circuit (I2C), Bluetooth, ZigBee, infrared (IR), near-field communication (NFC), Wi-Fi Direct, and/or any combination thereof.

Additionally, the communication 114 between the gaming machine 102 and the personal device 108 may utilize one or more authentication protocols. For example, the communication between 114 may include authentication protocols such as, but not limited to, public key infrastructure (PKI), secure socket layer (SSL)/transport layer security (TLS), Diffie-Hellman (DH) key exchange, internet protocol security (IPsec), mutual authentication, two-way handshake, three-way handshake, and/or any combination thereof.

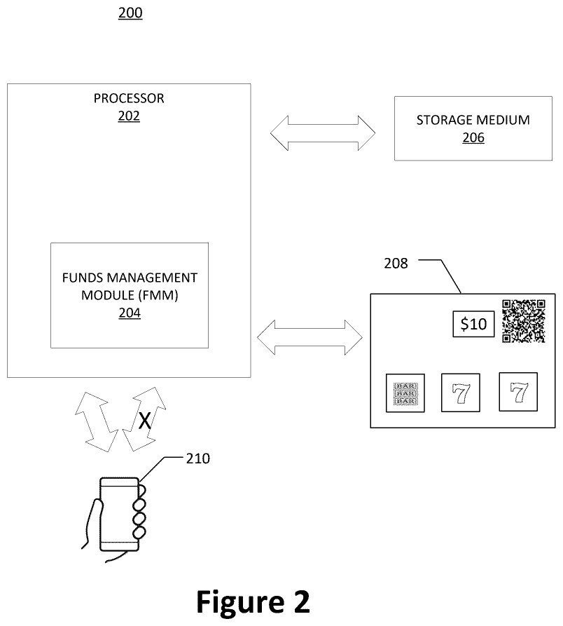

FIG. 2 illustrates a block diagram of system for facilitating for facilitating management of adding funds in a gaming environment, in accordance with various embodiments. In FIG. 2, a system 200 may include a processor 202, which may be communicatively coupled with a fund management module (FMM) 204 and a storage medium 206. In the system 200, the processor 202 may be communicatively coupled with a game 208. A personal device 210 may or may not be communicatively coupled with the processor 202, in accordance with one or embodiments. The system 200 may facilitate a secure method of adding funds in a gaming environment, in accordance with one or more embodiments, in accordance with various embodiments.

For example, referring back to the non-limiting example scenario of playing a game and adding funds, the system 200 may be associated with a game of chance. As previously described, responsive to receiving the indication to add funds, the FMM 204 under the control of the processor 202 (i.e., executed by the processor 202), the FMM 204 may cause to generate a machine-readable code. The player may utilize a personal communication device such as, but not limited to, a smartphone to scan the QR code. Responsive to scanning the QR code, the smartphone may launch an app. The app may generate an interface on the personal device 210 to facilitate adding funds.

As a result, the experience of the player may be enhanced because there may not be the need for interaction with any other person or device to facilitate adding funds to the gaming machine.

Even though the one non-limiting example scenario may be described with respect to a games of chance environment, it should be appreciated that the system 200 may be applicable to a wide variety of gaming environments as previously described. Accordingly, the claimed subject matter is not limited in this respect.

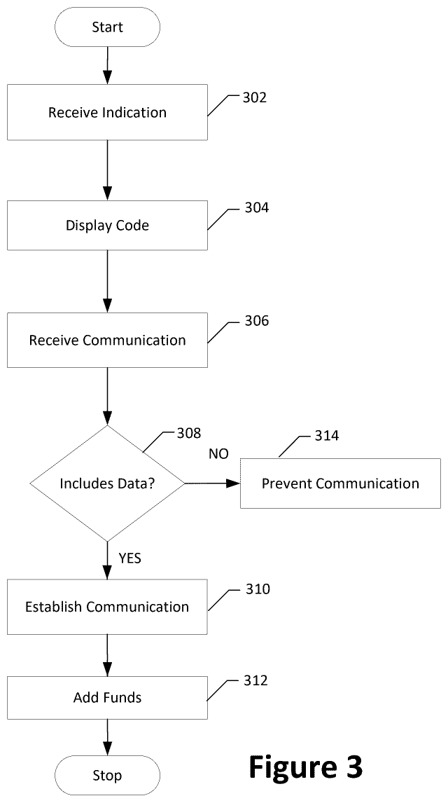

FIG. 3 illustrates an operational flow for facilitating securely adding funds to the gaming machine, in accordance with at least some of the embodiments described herein. In some portions of the description, illustrative implementations of the method are described with reference to the system 100 depicted in FIG. 1 and/or system 200 depicted in FIG. 2. However, the described embodiments are not limited to these depictions. More specifically, some elements depicted in FIG. 1 and FIG. 2 may be omitted from some implementations of the methods detailed herein. Furthermore, other elements not depicted in FIG. 1 and FIG. 2 may be used to implement example methods detailed herein.

Additionally, FIG. 3 employs block diagrams to illustrate the example methods detailed therein. These block diagrams may set out various functional blocks or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in the figures may be eliminated. In some examples, the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of claimed subject matter.

In some examples, operational flow 300 may be employed as part of a gaming platform, which may be included in a gaming machine. Beginning at block 302 (“Receive Indication”), the FMM 204 may receive an indication of adding funds.

Continuing from block 302 to 304 (“Display Code”), the FMM 204 may, responsive to the received indication, cause the gaming machine to display a machine-readable code, where the machine-readable code may be configured to cause to launch an application on a personal device.

Continuing from block 304 to 306 (“Receive Communication”), the FMM 204 may receive communication from the personal device, where the machine-readable code may have been read by the personal device causing the launching of the app on the personal device.

Continuing from block 306 to decision diamond 308 (“Includes Data?”), the FMM 204 may determine whether the received communication includes data configured to establish a secure two device communication between the gaming machine and the personal device.

At the decision diamond 308, if it is determined, by the FMM 204 that the received communication includes data, the FMM 204 may cause to establish communication between the gaming machine and the personal device based, at least in part, on the data at block 310 (“Establish Communication”).

Continuing from block 310 to 312 (“Add Funds”), the FMM 204 may cause the funds to be added to the gaming machine (i.e., to the game) corresponding to the indication (e.g., the amount of funds to be added).

At the decision diamond 308, if it is determined, by the FMM 204 that the received communication does not include the data, the FMM 204 may prevent establishment of communication between the gaming machine and the personal device at block 314 (“Prevent Communication”). As a result, a secure method of adding funds in a gaming environment may be facilitated, in accordance with one or more embodiments.

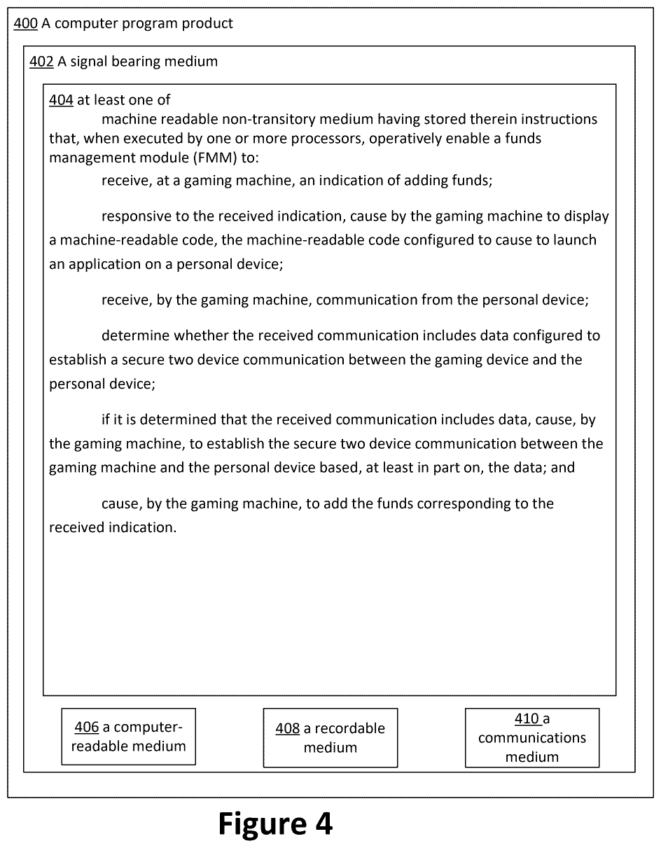

In general, the operational flow described with respect to FIG. 3 and elsewhere herein may be implemented as a computer program product, executable on any suitable computing system, or the like. For example, a computer program product for facilitating adding funds in a gaming environment may be provided. Example computer program products are described with respect to FIG. 4 and elsewhere herein.

FIG. 4 illustrates an example computer program product 400, arranged in accordance with at least some embodiments described herein. Computer program product 400 may include machine readable non-transitory medium having stored therein instructions that, when executed, cause the machine to facilitate a secure method of adding funds in a gaming environment according to the processes and methods discussed herein. Computer program product 400 may include a signal bearing medium 402. Signal bearing medium 402 may include one or more machine-readable instructions 404, which, when executed by one or more processors, may operatively enable a computing device to provide the functionality described herein. In various examples, some or all of the machine-readable instructions may be used by the devices discussed herein.

In some examples, the machine readable instructions 404 may include receiving, by an fund management module (FMM), data indicative of a selection of an event for participation by a user. The machine readable instructions 404 may include instructions to receive, by the FMM, an indication of adding funds. The machine readable instructions may include instructions to responsive to the received indication, cause by the FMM to display a machine readable code, where the machine readable code may be configured to cause to launch an application on a personal device. The machine readable instructions may include instructions to receive, by the FMM, communication from the personal device. The machine readable instructions may include instructions to determine whether the received communication includes data configured to establish a secure two device communication between the gaming device and the personal device. The machine readable instructions may include instructions to cause, by FMM machine, to establish the secure two device communication between the gaming machine and the personal device based, at least in part on, the data. The machine readable instructions may include instructions to cause, by the FMM, to add the funds corresponding to the received indication.

In some implementations, signal bearing medium 402 may encompass a computer-readable medium 406, such as, but not limited to, a hard disk drive, a Compact Disc (CD), a Digital Versatile Disk (DVD), a digital tape, memory, etc. In some implementations, the signal bearing medium 402 may encompass a recordable medium 408, such as, but not limited to, memory, read/write (R/W) CDs, R/W DVDs, etc. In some implementations, the signal bearing medium 402 may encompass a communications medium 410, such as, but not limited to, a digital and/or an analog communication medium (e.g., a fiber optic cable, a waveguide, a wired communication link, a wireless communication link, etc.). In some examples, the signal bearing medium 402 may encompass a machine readable non-transitory medium.

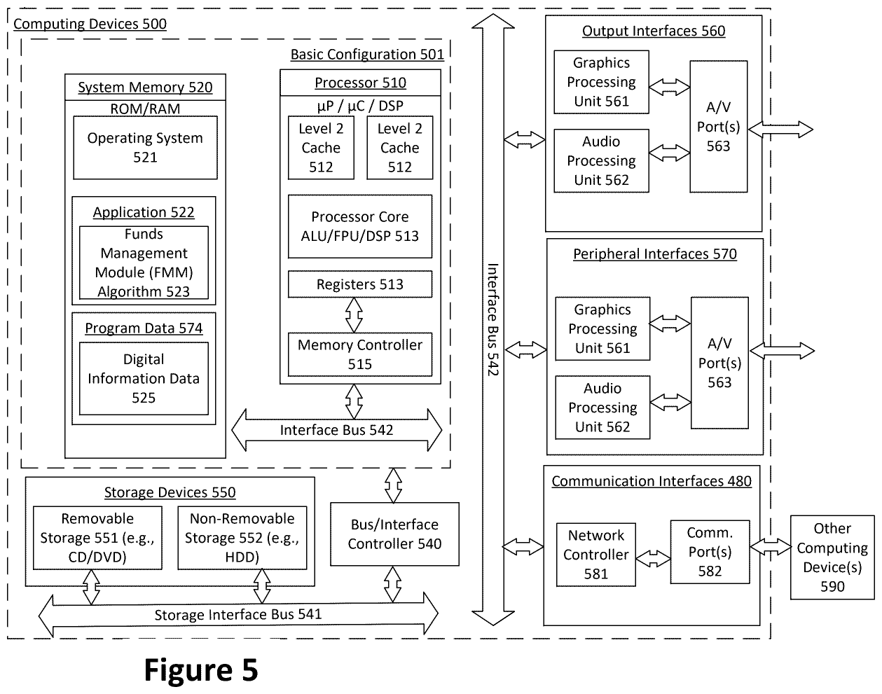

In general, the methods described with respect to FIG. 3 and elsewhere herein may be implemented in any suitable computing system and/or interactive electronic game. Example systems may be described with respect to FIG. 5 and elsewhere herein. In general, the system may be configured to facilitating adding funds in a gaming environment.

FIG. 5 is a block diagram illustrating an example computing device 500, such as might be embodied by a person skilled in the art, which is arranged in accordance with at least some embodiments of the present disclosure. In one example configuration 501, computing device 500 may include one or more processors 510 and system memory 520. A memory bus 530 may be used for communicating between the processor 510 and the system memory 520.

Depending on the desired configuration, processor 510 may be of any type including but not limited to a microprocessor (μP), a microcontroller (μC), a digital signal processor (DSP), a graphics processing unit (GPU), a processing unit utilizing reduced instruction set computer (RISC) architecture, and/or any combination thereof. Processor 510 may include one or more levels of caching, such as a level one cache 511 and a level two cache 512, a processor core 513, and registers 514. The processor core 513 may include an arithmetic logic unit (ALU), a floating-point unit (FPU), a digital signal processing core (DSP Core), or any combination thereof. A memory controller 515 may also be used with the processor 510, or in some implementations the memory controller 515 may be an internal part of the processor 510.

Depending on the desired configuration, the system memory 520 may be of any type including but not limited to volatile memory (such as RAM), non-volatile memory (such as ROM, flash memory, etc.) or any combination thereof. System memory 520 may include an operating system 521, one or more applications 522, and program data 524. Application 522 may include funds management module (FMM) 523 that is arranged to perform the functions as described herein including the functional blocks and/or actions described. Program Data 524 may include digital information data 525 for use with FMM 523. In some example embodiments, application 522 may be arranged to operate with program data 524 on an operating system 521 such that implementations of facilitating FMM configured to facilitate secure adding of funds in a gaming environment as described herein. For example, apparatus described in the present disclosure may comprise all or a portion of computing device 500 and be capable of performing all or a portion of application 522 such that implementations of facilitating adding of funds in a gaming environment may be provided as described herein. This described basic configuration is illustrated in FIG. 5 by those components within dashed line 501.

Computing device 500 may have additional features or functionality, and additional interfaces to facilitate communications between the basic configuration 501 and any required devices and interfaces. For example, a bus/interface controller 540 may be used to facilitate communications between the basic configuration 501 and one or more data storage devices 550 via a storage interface bus 541. The data storage devices 550 may be removable storage devices 551, non-removable storage devices 552, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable, and non-removable media implemented in any method or technology for storage of information, such as computer readable instructions, data structures, program modules, or other data.

System memory 520, removable storage 551 and non-removable storage 552 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of device 500.

Computing device 500 may also include an interface bus 542 for facilitating communication from various interface devices (e.g., output interfaces, peripheral interfaces, and communication interfaces) to the basic configuration 501 via the bus/interface controller 540. Example output interfaces 560 may include a graphics processing unit 561 and an audio processing unit 562, which may be configured to communicate to various external devices such as a display or speakers via one or more A/V ports 563. Example peripheral interfaces 560 may include a serial interface controller 571 or a parallel interface controller 572, which may be configured to communicate with external devices such as input devices (e.g., keyboard, mouse, pen, voice input device, touch input device, etc.) or other peripheral devices (e.g., printer, scanner, etc.) via one or more I/O ports 573. An example communication interface 580 includes a network controller 581, which may be arranged to facilitate communications with one or more other computing devices 590 over a network communication via one or more communication ports 582. A communication connection is one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

Computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 500 may also be implemented as a personal computer including both laptop computer and non-laptop computer configurations. In addition, computing device 500 may be implemented as part of a wireless base station or other wireless system or device.

It should be appreciated after review of this disclosure that it is contemplated within the scope and spirit of the present disclosure that the claimed subject matter may include a wide variety of routers, modems, computing devices, communication mediums/approaches, etc. Accordingly, the claimed subject matter is not limited in these respects.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

Other embodiments include combinations and sub-combinations of features described or shown in the drawings herein, including for example, embodiments that are equivalent to: providing or applying a feature in a different order than in a described embodiment, extracting an individual feature from one embodiment and inserting such feature into another embodiment; removing one or more features from an embodiment; or both removing one or more features from an embodiment and adding one or more features extracted from one or more other embodiments, while providing the advantages of the features incorporated in such combinations and sub-combinations. As used in this paragraph, feature or features can refer to the structures and/or functions of an apparatus, article of manufacture or system, and/or the steps, acts, or modalities of a method.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussion utilizing terms such as “processing,” “computing,” “calculating,” “determining” or the like refer to actions or processes of a computing device that manipulates or transforms data represented as physical electronic or magnetic quantities within memories, registers, or other information storage devices, transmission devices, or display devices of the computing device.

Claimed subject matter is not limited in scope to the particular implementations described herein. For example, some implementations may be in hardware, such as those employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon that, when executed by a computing device such as a computing system, computing platform, or other system, for example, may result in execution of a processor in accordance with claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skilled in the art in light of this disclosure. In addition, those skilled in the art will appreciate that the mechanisms of the subject matter described herein are capable of being distributed as a product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter is not limited to the particular examples disclosed, but that such claimed subject matter also may include all implementations falling within the scope of the appended claims, and equivalents thereof.

1. A method of facilitating adding funds within a gaming environment, the method comprising:
receiving, at a gaming machine, an indication of adding funds;
responsive to the received indication, causing by the gaming machine to display a machine-readable code, the machine-readable code configured to cause to launch an application on a personal device;
receiving, by the gaming machine, communication from the personal device;
determining whether the received communication includes data configured to establish a secure two device communication between the gaming device and the personal device;
if it is determined that the received communication includes data, causing, by the gaming machine, to establish the secure two device communication between the gaming machine and the personal device based, at least in part on, the data; and
causing, by the gaming machine, to add the funds corresponding to the received indication.

2. The method of claim 1 further comprising preventing, by the gaming machine, communication between the gaming machine and the personal device if it is determined that the received communication does not include the data.

3. The method of claim 1, wherein receiving the indication comprises receiving an indication of activation of a button on the gaming machine.

4. The method of claim 1, wherein causing to display comprises causing to display on a dedicated portion of a larger display.

5. The method of 4, wherein the dedicated portion comprises a display configured to display available funds.

6. The method of claim 1, wherein receiving communication comprises receiving communication via a short communication protocol.

7. The method of claim 6, wherein the short communication protocol comprises one or more of universal asynchronous receiver-transmitter (UART), serial peripheral interface (SPI), inter-integrated circuit (I2C), Bluetooth, ZigBee, infrared (IR), near-field communication (NFC), or Wi-Fi Direct.

8. The method of claim 1, wherein determining whether the received communication has data comprises determining whether the received communication has an authentication protocol.

9. The method of claim 8, wherein the authentication protocol includes one or more of public key infrastructure (PKI), secure socket layer (SSL)/transport layer security (TLS), Diffie-Hellman (DH) key exchange, internet protocol security (IPsec), mutual authentication, two-way handshake, or three-way handshake.
